(19) United States
(12) Patent Application Publication
(10) Pub. No.: US 2020/0364216 A1
(43) Pub. Date: Nov. 19, 2020

(54) METHOD, APPARATUS AND STORAGE MEDIUM FOR UPDATING MODEL PARAMETER

(71) Applicant: BAIDU ONLINE NETWORK TECHNOLOGY (BEIJING) CO., LTD., Beijing (CN)

(72) Inventors: Miao FAN, Beijing (CN); Yue FENG, Beijing (CN); Mingming SUN, Beijing (CN); Ping LI, Beijing (CN)

(21) Appl. No.: 16/986,092

(22) Filed: Aug. 5, 2020

Related U.S. Application Data
(63) Continuation of application No. PCT/CN2019/077166, filed on Mar. 6, 2019.

(30) Foreign Application Priority Data
Apr. 17, 2018 (CN) 201810344086.8

(51) Int. Cl. G06F 16/23

(52) U.S. Cl. CPC G06F 16/2379

(57) ABSTRACT

A method, a device, and a computer-readable storage medium for updating model parameters are provided. The method includes: according to current values of a first set of parameters of a comment evaluation model, extracting a first feature of a first comment and a second feature of a second comment by using the comment evaluation model; determining at least one similarity measure of the first comment and the second comment based on the first feature and the second feature; and in response to the first comment being marked with a corresponding actual degree of usefulness and the second comment not being marked with a corresponding actual degree of usefulness, updating the current values of the first set of parameters at least based on the at least one similarity measure so as to obtain updated values of the first set of parameters.

### CROSS-REFERENCE TO RELATED APPLICATIONS

This application is a continuation application of PCT/CN2019/077166 filed on Mar. 06, 2019, which claims priority to and benefits of Chinese Patent Application No. 201810344086.8 filed on Apr. 17, 2018.The entire contents of the aforementioned applications are incorporated herein by reference.

### TECHNICAL FIELD

Embodiments of the disclosure generally relate to a field of computers, and more particularly, to a method, a device, and a computer-readable storage medium for updating model parameters.

### BACKGROUND

With the development of network technologies, more and more Internet platforms support generation of user-generated content (UGC). As a result, users can publicly comment on specific objects on many Internet platforms. Such comments not only enrich relevant information of the object being reviewed (e.g., products, services, and content such as news, videos, and short texts), but also help other users to understand quality and characteristics of the object being reviewed.

Since comments are usually generated by users autonomously, not all comments can provide other users with useful or valuable information about the object being reviewed, and even some comments may be irrelevant to the object being reviewed. If there are massive comments on the object being reviewed, and useful comments are mixed with useless comments, it is difficult for other users to quickly obtain useful information from the massive comments, and the useless information is not conducive to the correct evaluation (e.g. determining whether the object is recommendable) from the provider or a third party for the object being reviewed. Therefore, it is desirable to be able to distinguish values or degrees of usefulness of the comments.

It has been proposed that a learning model can be trained using training data by a method of machine learning to obtain a learning model that can be used to automatically evaluate the degrees of usefulness of comments. Such a model training process usually involves various costs, such as labor costs, and computing costs. It is expected to reduce training costs as much as possible while ensuring good model learning.

### SUMMARY

In a first aspect, the disclosure provides a method for updating model parameters. The method includes: according to current values of a first set of parameters of a comment evaluation model, extracting a first feature of a first comment and a second feature of a second comment by using the comment evaluation model, in which the comment evaluation model is configured to evaluate a degree of usefulness of a comment; determining at least one similarity measure of the first comment and the second comment based on the first feature and the second feature; and in response to the first comment being marked with a corresponding actual degree of usefulness and the second comment not being marked with a corresponding actual degree of usefulness, updating the current values of the first set of parameters at least based on the at least one similarity measure so as to obtain updated values of the first set of parameters.

In a second aspect, the disclosure provides an apparatus for updating model parameters. The apparatus includes a processor; and a non-transitory computer readable storage medium storing a plurality of instruction modules that are executed by the processor, the plurality of instruction modules include: a feature extraction module, configured to, according to current values of a first set of parameters of a comment evaluation model, extract a first feature of a first comment and a second feature of a second comment by using the comment evaluation model, in which the comment evaluation model is configured to evaluate a degree of usefulness of a comment; a measure determination module, configured to determine at least one similarity measure of the first comment and the second comment based on the first feature and the second feature; and a parameter updating module, configured to, in response to the first comment being marked with a corresponding actual degree of usefulness and the second comment not being marked with a corresponding actual degree of usefulness, update the current values of the first set of parameters at least based on the at least one similarity measure so as to obtain updated values of the first set of parameters.

In a third aspect, the disclosure provides a computer-readable storage medium having a computer program stored thereon, in which when the computer program is executed by a processor, the method according to the first aspect is implemented.

It is understood that what is described in the Summary section is not intended to limit key or important features of the embodiments of the disclosure, nor is it intended to limit the scope of the disclosure. Additional features of the disclosure will become readily understood from the following description.

### BRIEF DESCRIPTION OF THE DRAWINGS

The above and/or additional features, aspects, and advantages of embodiments of the disclosure will become apparent and more readily appreciated from the following descriptions made with reference to the drawings. The same or similar reference numerals indicate the same or similar elements in the drawings, in which:

FIG. 1 is a schematic diagram of an example environment in which embodiments of the disclosure can be implemented.

FIG. 2 is a flowchart of a process of updating model parameters according to some embodiments of the disclosure.

FIG. 3 is a block diagram of a system for updating model parameters according to some embodiments of the disclosure.

FIG. 4 is a schematic diagram of an example structure of a comment evaluation model according to some embodiments of the disclosure.

FIG. 5 is a block diagram of an apparatus for updating model parameters according to an embodiment of the disclosure.

FIG. 6 is a block diagram of a computing device capable of implementing embodiments of the disclosure.

### DETAILED DESCRIPTION

Embodiments of the disclosure will be described in more detail below with reference to the drawings. Although the drawings illustrate certain embodiments of the disclosure, it should be understood that the disclosure may be implemented in various forms and should not be construed as limited to the embodiments set forth herein, but rather these embodiments are provided for a more thorough and complete understanding of the disclosure. It should be understood that the drawings and embodiments of the disclosure are for exemplary purposes only, and are not intended to limit the protection scope of the disclosure.

In the description of the embodiments of the disclosure, the term “including” and similar terms should be understood as inclusive, that is, “including but being not limited to”. The term “based on” should be understood as “based at least in part on”. The term “one embodiment” or “the embodiment” should be understood as “at least one embodiment”. The terms such as “first”, and “second” may refer to different objects or the same object. Additional explicit and implicit definitions may be included below.

In the description of the embodiments of the disclosure, the term “comment” may also be referred to as a comment, a message, or a reply, and refers to content (e.g., opinions, suggestions, reviews, and opinions) related to a certain object or a certain type of objects. Such objects can be physical or virtual objects, such as products, services, and content in specific forms (e.g. news, video, and short text). Comments are usually written by corresponding reviewers and submitted to a specific web host. In the embodiments of the disclosure, discussion is based on the comments given in the form of text. In some cases, comments may also include content given in the form of audio, video, and pictures. For these situations, content given in the form of audio, video, and pictures can be converted into content in the form of text or ignored.

In the description of the embodiments of the disclosure, “degree of usefulness” of a comment refers to a degree to which the comment helps a user to evaluate a target object, and is also referred to as value or usefulness of the comment. Generally, users expect to be able to evaluate, understand, or recognize one or more aspects (such as quality, features, functions, advantages and disadvantages, and details) of a particular object from comments given by reviewers. If the comments contain information on these aspects, the users tend to consider the comments to be valuable or useful, otherwise, the comments are considered worthless or useless. The degree of usefulness of the comment indicates whether the comment is useful (for example, indicated by 0 or 1), or indicates a specific degree of usefulness of the comment or a specific degree of uselessness (for example, indicated by a specific value in a certain numerical range).

In the description of the embodiments of the disclosure, the term “learning model” or “model” refers to a model that can learn a corresponding set of parameters from training data to represent correspondence between input and output of the model. During the training process, the set of parameters of the model is continuously updated from initial values until they meet certain conditions. The set of parameters obtained after the training is completed, processes a given input to generate a corresponding output. The “learning model” can sometimes be called “neural network”, “learning network”, “deep learning network” or simply “network”. These terms are used interchangeably herein.

As mentioned above, it is expected to use training data to train a learning model by a machine learning method to obtain a learning model that can be used to automatically evaluate a degree of usefulness of a comment. The training data used to train such learning models often includes comments and degrees of usefulness of the comments (e.g. whether they are valuable). Comments that have been labeled with corresponding actual degrees of usefulness are also referred to as labeled comments, while comments that have not been labeled with corresponding actual degrees of usefulness are referred to as unlabeled comments. In order to be able to train an effective learning model for value evaluation of comments, a large number of labeled comments are generally required for training.

In current applications, many platforms (such as Internet websites) that display comments determine a value of a comment by crowdsourcing, that is, other Internet users are encouraged to manually vote on the value of the comment. However, due to extra works for users viewing comments, statistics found that a percentage of obtaining comments on the values labeled by the users is low. Currently, when using the machine learning method to train learning models, most rely only on a small number of labeled comments available from these comment sources. However, the small number of labeled comments usually leads to lack of sufficient generalization (popularization) ability of the trained learning model, and a large amount of unlabeled comment information in many platforms cannot be used, resulting in a lot of waste of existing data.

In other solutions, in order to obtain more labeled comments that can be used for training, it may take time and capital investment to hire personnel for manual labeling, which results in a significant increasing in model training costs.

Embodiments of the disclosure provide a solution for updating model parameters. In this solution, unlabeled comments can be used with labeled comment data to train a comment evaluation model, and to update a set of parameters of the comment evaluation model. In detail, current values of the set of parameters of the comment evaluation model can be used to extract features of a pair of comments, and the similarity measure of the pair of comments can be determined based on the extracted features. If the pair of comments contain a labeled comment and an unlabeled comment, the current values of the set of parameters are updated based on the similarity measure to obtain updated values of the set of parameters. Through such a solution, a small number of labeled comments and a large number of unlabeled comments can be used to execute the updating of the model parameters, thereby ensuring effective model learning while greatly reducing the time and cost of labeling comment manually. Therefore, the solution of the disclosure can advantageously realize automatic, effective, and low-cost updating of the model parameters.

The embodiments of the disclosure are described in detail with reference to the drawings.

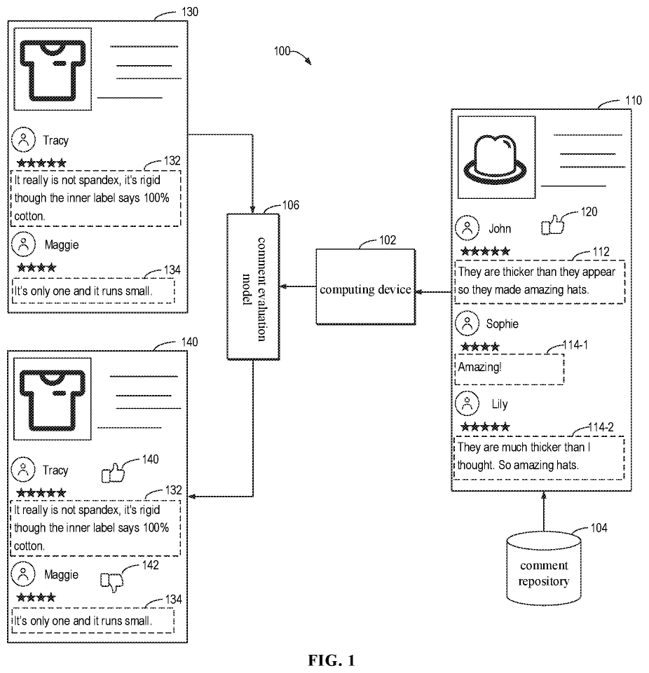

FIG. 1 is a schematic diagram of an example environment 100 in which embodiments of the disclosure can be implemented. In this example environment 100, a computing device 102 uses training comments to update a set of parameters of a comment evaluation model 106 to obtain the comment evaluation model 106 after training. The comment evaluation model 106 is configured to evaluate a degree of a comment specified for a certain object on helping users to evaluate the object, that is, to evaluate the degree of usefulness or value of the comment.

The computing device 102 may obtain comments for training from a comment repository 104. The comment repository 104 may receive, request, or crawl comments from various comment sources and store these comments. Such comments can be presented on web pages of Internet websites. For example, in FIG. 1, the computing device 102 obtains a web page 110 from the comment repository 104, and the web page 110 presents one or more comments 112, 114-1, and 114-2 on “hat” and these comments are reviewed by “John”, “Sophie” and “Lily” respectively.

The computing device 102 expects to use these comments to train the comment evaluation model 106, that is, to update the set of parameters of the comment evaluation model 106. Generally, comments labeled with corresponding degrees of usefulness can be used directly for updating parameters of the model. For example, in FIG. 1, the comment 112 has a corresponding usefulness degree indicator 120 indicating that the comment is useful. Based on such a comment 112, the computing device 102 may cause the set of parameters of the comment evaluation model 106 to be updated to be able to identify what kinds of comments are useful comments. The computing device 102 may also obtain some unlabeled comments (for example, the comment 114-1, and the comment 114-2, sometimes collectively or individually referred as the comment 114), and the degrees of usefulness of these unlabeled comments are unknown. According to an embodiment of the disclosure, the computing device 102 may also utilize these unlabeled comments 114 to update the set of parameters of the comment evaluation model 106. Certainly, in addition to the comments 112 and 114 shown in FIG. 1, the computing device 102 may also obtain more comments to update the set of parameters of the comment evaluation model 106.

After the training process is completed, the values of the set of parameters of the comment evaluation model 106 may be determined. The trained comment evaluation model 106 is configured to evaluate a degree of usefulness of any comment inputted. For example, the comments 132 and 134 in the web page 130 may be input to the comment evaluation model 106. The comment evaluation model 106 may process the comments 132 and 134 respectively based on the trained set of parameters to determine degrees of usefulness of the two comments. The determined degrees of usefulness can be presented along with the corresponding comments. As illustrated in FIG. 1, the web page 130 may be changed to a web page 140, in which the comment 132 is labeled with a “useful” indicator 142 indicating that the comment 132 helps a user to evaluate a specific object involved in the evaluation. The comment 134 is labeled with a “useless” indicator 144 indicating that the comment 134 is not useful to help the user to evaluate the specific object involved in the evaluation.

It is understood that the web pages 110, 130, and 140 shown in FIG. 1 are merely examples, and FIG. 1 only shows one possible application of the embodiment of the disclosure. In other embodiments, the content of the comment and/or an indication of the corresponding degree of usefulness may be provided directly instead of providing a webpage where the comment is recorded, and only an evaluation result on the value of the comment may be output. Such evaluation results can also be used by third parties, such as providers of specific objects, and Internet platforms with comments, for presentations associated with comments, or for other purposes, such as product promotion, and display preference of useful comments. The comment results may also indicate whether the comment is useful/valuable in various ways, and is not limited to the indicator schematically shown in FIG. 1.

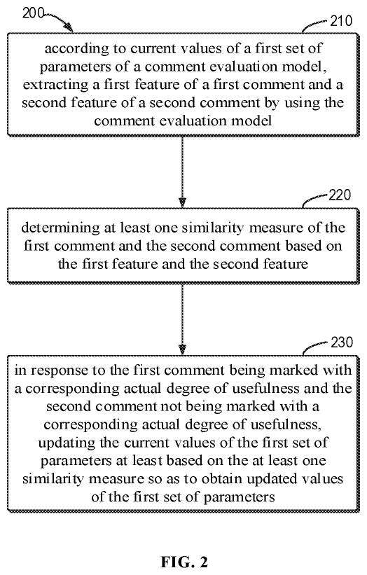

In order to more clearly understand the solution for updating model parameters according to the embodiments of the disclosure, the solution is described in detail with reference to FIG. 2. FIG. 2 is a flowchart of a process 200 for updating model parameters according to some embodiments of the disclosure. The process 200 may be implemented by the computing device 102 of FIG. 1. For ease of discussion, the process 200 is described in combination with FIG. 1.

At block 210, according to current values of a set of parameters of the comment evaluation model 106, the computing device 102 extracts a first feature of a first comment and a second feature of a second comment by using the comment evaluation model 106. For ease of discussion, the set of parameters of the comment evaluation model 106 is sometimes referred to as a first set of parameters. The feature of the comment refers to information that characterizes the semantics of the comment. The feature can be extracted as the form of measures.

The comment evaluation model 106 may be any learning model designed to evaluate a degree of usefulness of a comment. The comment evaluation model 106 may be constructed based on a deep learning network capable of processing text content such as a convolutional neural network (CNN). The comment evaluation model 106 can be generally divided into two portions by functions, namely a feature extraction portion and a usefulness degree evaluation portion. The feature extraction portion is designed to process input comments to extract the features of the comments, and the usefulness degree evaluation portion is designed to determine degrees of usefulness of the comments based on the extracted features. The embodiments of the disclosure focus on how to update the parameters of the comment evaluation model, so any learning model designed to update model parameters through training data can be adopted. The scope of the disclosure is not limited in this regard.

The first set of parameters of the comment evaluation model 106 refers to processing parameters to be used by the comment evaluation model 106 in implementing feature extraction and usefulness degree evaluation. In the initial stage of training, the first set of parameters may be set to random values, or one or more parameters in the first set of parameters may have a pre-trained value. During the training process, the first set of parameters is continuously updated from the initial values. Generally, the training process is an iterative process. In each iteration, processing is implemented based on the current values of the first set of parameters for further updating. When convergence conditions are met, the training process is completed and the current values of the first set of parameters is determined.

In some embodiments, the computing device 102 may select the first comment and the second comment from a set of comments. The set of comments are comments that are obtained in advance and used to learn the parameters of the comment evaluation model 106. These comments may include comments that are labeled with corresponding actual degrees of usefulness and comments that are not labeled with corresponding actual degrees of usefulness. In some embodiments, the computing device 102 may select the first comment and the second comment from the set of comments in a random manner. The first and second comments selected in this way may include one labeled comment and one unlabeled comment, certainly, sometimes it is also possible to include two labeled comments or two unlabeled comments.

For the case where the first comment and the second comment include one labeled comment and one unlabeled comment, according to the embodiments of the disclosure, the unlabeled comment can also be used for updating model parameters. In detail, at block 220, the computing device 102 determines at least one similarity measure of the first comment and the second comment based on the first feature and the second feature. Here, the first feature and the second feature are both extracted based on the current values of the first set of parameters of the comment evaluation model 106. Then, at block 230, in response to the first comment being labeled with the corresponding actual degree of usefulness and the second comment not being labeled with the corresponding actual degree of usefulness, the computing device 102 updates the current values of the first set of parameters at least based on the at least one similarity measure so as to obtain updated values of the first set of parameters.

Generally, for labeled comments, to update model parameters, the set of parameters is updated based on a difference between the actual degree of usefulness of the comment and an estimated degree of usefulness of the comment which is determined based on the current values of the set of parameters. For unlabeled comments, it is impossible to know the actual degrees of usefulness of the comments. In order to be able to use such unlabeled comments for model learning without manually labelling the actual degrees of usefulness, in the embodiments of the disclosure, the similarity between the labeled comment and the unlabeled comment may be used to determine how to update the current values of the first set of parameters. In some embodiments, the process 200 may be repeatedly performed for different pairs of comments, and the values of the first set of parameters may be continuously updated, so as to obtain the determined values of the first set of parameters of the comment evaluation model 106.

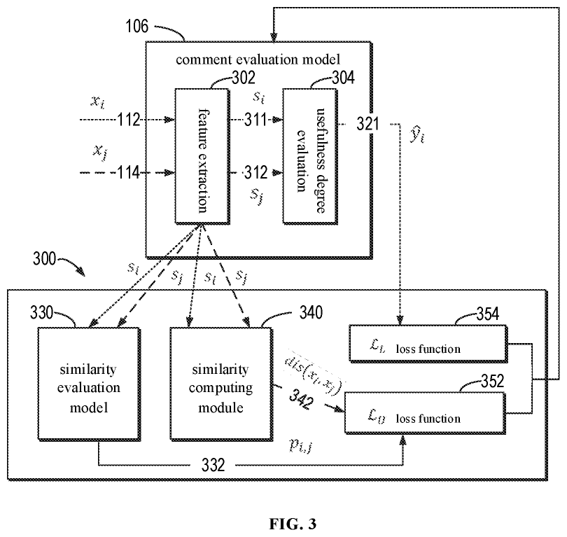

The following are detailed description on how to update the first set of parameters of the comment evaluation model 106 based on the similarity measure of the two comments. For ease of description and understanding, the process is described in detail with reference to FIG. 3. FIG. 3 is a block diagram of a system 300 for updating model parameters according to some embodiments of the disclosure. The system 300 may be configured on the computing device 102.

As illustrated in FIG. 3, the comment evaluation model 106 can be generally divided into two portions, that is, a feature extraction portion 302 and a usefulness degree evaluation portion 304. The feature extraction portion 302 is designed to process input comments to extract the features of the comments, and the usefulness degree evaluation portion 304 is designed to determine the degrees of usefulness of the comments based on the extracted features. Assume that the first comment is the labeled comment 112 and the second comment is the unlabeled comment 114 in FIG. 1, which are denoted as Xᵢ and Xⱼ, respectively. As illustrated in FIG. 3, in order to implement the updating of the first set of parameters of the comment evaluation model 106, the first comment 112 and the second comment 114 are respectively input into the comment evaluation model 106, and based on the current values of the set of parameters of the model, the model is used to extract a first feature 311 (represented as “Sᵢ”) of the first comment 112 and a second feature 312 (represented as “Sⱼ”) of the second comment 114, respectively. The feature extraction portion 302 may extract features for the first comment 112 and the second comment 114 in any order.

In the embodiment of FIG. 3, the system 300 for updating model parameters, includes a portion for determining a similarity measure of the first comment 112 and the second comment 114, which has a similarity evaluation model 330 and a similarity computing module 340. The similarity evaluation model 330 is a learning model for determining a similarity measure of two comments based on the features of the two input comments. Therefore, the similarity evaluation model 330 also has its own parameter set (referred to as a second set of parameters). The second set of parameters is initially set to random values or other predetermined values, and may also be updated in subsequent processes in some embodiments, for example, together with the first set of parameters of the comment evaluation model 106.

In some embodiments, according to the current values of the second set of parameters of the similarity evaluation model 330, the computing device 102 uses the similarity evaluation model 330 to process the first feature Sᵢ 311 and the first feature Sⱼ 312 to determine the first similarity measure 332 of the first comment 112 and the second comment 114. In some examples, the similarity evaluation model 330 is configured to determine a probability that the first comment 112 is similar to the second comment 114. The processing in the similarity evaluation model 330 can be represented as follows:

p_{i,j}=σ(wₛ^{T}(sᵢ⊕sⱼ)+bₛ), (1)

where p_{i,j} represents the first similarity measure 332, σ (.) represents an activation function used by the similarity evaluation model 330, wₛ^{T} and bₛ constitute the second set of parameters of the similarity evaluation model 330, and ⊕ represents an XOR operation. Here, the first feature and the second feature can be represented in a form of vector, including a plurality of elements with binary values of 0 and 1.

According to formula (1), the similarity evaluation model 330 determines an XOR result of the first feature Sᵢ 311 and the first feature Sⱼ 312, and processes the XOR result based on the current values of the second set of parameters to determine the first similarity measure p_{i,j} 332 indicating a possibility of similarity of the first comment 112 and the second comment 114. The first similarity measure p_{i,j} 332 can take a value from 0 to 1, where the larger the value of p_{i,j}, the higher the probability that the first comment 112 is similar to the second comment 114. Otherwise, the possibility of similarity is lower. It should be understood that formula (1) shows only one example process of the similarity evaluation model 330. In other embodiments, the similarity evaluation model 330 may also be designed to calculate the first similarity measure using other processing methods.

In addition to determining the similarity measure of the first comment 112 and the second comment 114 based on the learning model 330, in the system 300, the similarity computing module 340 is configured to calculate a difference between the first feature Sᵢ 311 and the first feature Sⱼ 312 to determine the second similarity measure 342 of the first comment 112 and the second comment 114. In some embodiments, the second similarity measure may be calculated as a larger value for indicating a larger difference between the two features, so the similarity of the corresponding two comments is lower, and as a smaller value for indicating a smaller difference between the two features, so the similarity of the corresponding two comments is higher.

In some embodiments, if the first feature Sᵢ 311 and the first feature Sⱼ 312 are represented in a form of vector, the second similarity measure may be calculated as the distance between the first feature Sᵢ 311 and the first feature Sⱼ 312, for example, a Euclidean distance, which can be represented as follows:

dis(xᵢ, xⱼ)=∥sᵢ−sⱼ∥₂ (2)

where dis(xᵢ, xⱼ) represents the second similarity measure 342, and ∥ ∥₂ represents the processing of obtaining the 2-norm of (sᵢ−sⱼ), which is used to calculate the distance between Sᵢ and Sⱼ, the distance indicates the difference between Sᵢ and Sⱼ. In formula (2), the second similarity measure 342 is determined as the difference between the first feature Sᵢ 311 and the first feature Sⱼ 312. However, in other embodiments, the value of the second similarity measure 342 may also be determined in other ways based on the difference between the two features. It should be understood that formula (2) shows only one way of calculating the difference between the first feature Sᵢ 311 and the first feature Sⱼ 312, and any other method capable of determining the difference of measures can also be adopted.

Based on the first similarity measure 332 and the second similarity measure 342, the system 300 may update the current values of the first set of parameters of the comment evaluation model 106. In some embodiments, based on a probability that the first comment 112 is similar to the second comment 114, which is indicated by the first similarity measure 332, it is determined whether the second comment 114 as the unlabeled comment is a positive sample (that is, the sample that is beneficial for the comment evaluation model 106 to learn to determine the degrees of usefulness of comments) and updates based on this. For example, in the example shown in FIG. 1, the similarity between the unlabeled comment 114-2 and the labeled comment 112 is high, which may also be the case with the first similarity measure 332 determined during the training process, thus the comment 114-2 is considered as a positive sample. However, the similarity between the unlabeled comment 114-1 and the labeled comment 112 is low, and the determined first similarity measure 332 may also be able to indicate this case, so the unlabeled comment 114-1 is considered as a negative sample (opposed to the positive sample).

If it is currently determined that the second comment 114 is the positive sample (for example, the first similarity measure 332 exceeds the preset threshold), the system 300 may update the current values of the first set of parameters while enabling the updated values to cause the comment evaluation model 106 to extract features with a smaller difference for the first comment and the second comment. In this way of updating, the first set of parameters of the comment evaluation model 106 can be updated to the trend of extracting the same/similar features for the same/similar comments. If it is currently determined that the second comment 114 is the negative sample (for example, the first similarity measure 332 does not exceed the preset threshold), the system 300 may update the current values of the first set of parameters while enabling the updated values to cause the comment evaluation model 106 to extract features with a greater difference for the first comment and the second comment. In this way of updating, the first set of parameters of the comment evaluation model 106 can be updated to the trend of extracting significantly different features for different comments. The setting of the preset threshold may depend on the value range of the first similarity measure 332. For example, if the value ranges from 0 to 1, the preset threshold is set to 0.5.

During model training, most training methods determine a loss function (or a utility function) as an optimization object. The loss function is structured to be related to model parameters (for example, to the output of the model and the output is related to the overall parameters of the model) in order to determine the convergence of training by minimizing the loss function (or maximizing the utility function). To facilitate understanding of the embodiments of the disclosure, the introduction of how to perform a parameter set updating based on the loss function is continued.

In the parameter updating process, an updating amplitude of the parameter set may be determined based on the loss function. The updating of the parameter set can be based on a variety of training methods. Gradient descent method, especially stochastic gradient descent method, is a common method used in these methods. According to the stochastic gradient descent algorithm, each parameter in the parameter set can be determined based on gradients of the loss function related to the parameter set.

According to the training methods based on the loss function and the stochastic gradient, in the example of FIG. 3, the system 300 may further include an [symbol] _{U} loss function module 352 configured to determine how the current values of the first set of parameters of the comment evaluation model 106 based on unlabeled comments (e.g., the comment 114) is updated. Specifically, the [symbol] _{U} loss function module 352 is configured to determine an updating magnitude of the first set of parameters based on the first similarity measure 332 and the second similarity measure 342. As mentioned above, according to the value of the first similarity measure 332 determined by the similarity evaluation model 330, the first set of parameters is updated differently, so the [symbol] _{U} loss function module 352 can also determine the gradients of the loss function in different ways. This can be reflected in the loss function as follows:

$$∇ {ℒ}_{U} = \{ \begin{matrix}{\sum }_{i , j = 1}^{M + N} {p}_{i , j} ∇ dis ( {x}_{i} , {x}_{j} ) & if {p}_{i , j} > 0.5 \\ {\sum }_{i , j = 1}^{M + N} ( 1 - {p}_{i , j} ) ∇ max ( 0 , γ - dis ( {x}_{i} , {x}_{j} ) ) & if {p}_{i , j} \leq 0.5\end{matrix} \qquad ( 3 )$$

where [symbol] _{U} represents the loss function associated with unlabeled comments, ∇ represents the gradient operation, N represents the number of labeled comments in a set of comments used for training, M represents the number of unlabeled comments, and max (.) represents a maximum value, and γ is a preset value, which can be set to an arbitrary value (for example, a value between 0 and 1) as needed.

When the first similarity measure 332 is greater than 0.5, it indicates that the probability that the first comment 112 is similar to the second comment 114 is high, and the gradient of the loss function [symbol] _{U} may be determined by using a upper part of formula (3), so that the updated values of the first set of parameters may be to cause the comment evaluation model 106 to determine more similar features for the first comment 112 and the second comment 114. If the first similarity measure 332 is less than or equal to 0.5, it indicates that the probability that the first comment 112 is similar to the second comment 114 is low, and the gradient of the loss function [symbol] _{U} may be determined by using a lower part of formula (3), so that the updated values of the first set of parameters may be to cause the comment evaluation model 106 to determine features with the greater difference for the first comment 112 and the second comment 114.

The gradient of the loss function [symbol] _{U} may be determined relative to any parameter to be updated in the first set of parameters, and the value of the parameter is updated accordingly. Based on the loss function [symbol] _{U}, the comment evaluation model 106 can learn some knowledge from the unlabeled comments, which is beneficial to realize the objective of the model (that is, to evaluate the degrees of usefulness of the comments). In some embodiments, in addition to jointly determining the updating of the first set of parameters based on the first similarity measure 332 and the second similarity measure 334, only the first similarity measure 332 may be based on to implement updating. In these embodiments, the loss function [symbol] _{U} may be configured to be related to only the first similarity measure 332.

In some embodiments, since the second set of parameters of the similarity evaluation model 330 also needs to be learned (i.e., updated), the system 300 may adopt a similar method as the comment evaluation model 106, and update the similarity evaluation model 330 based on the first similarity measure 332 and the second similarity measure 342. Specifically, in response to the first similarity measure 331 exceeding the preset threshold, the current values of the second set of parameters may be updated so that the updated values cause the similarity evaluation model 330 to determine that the similarity between the first comment 112 and the second comment 114 is higher. In this way of updating, the second set of parameters of the similarity evaluation model 330 can be updated to a trend of providing a higher similarity probability for the same/similar comments. In addition, in response to the first similarity measure 332 not exceeding the preset threshold, the current values of the second set of parameters may be updated so that the updated values cause the similarity evaluation model 330 to determine that the similarity between the first comment 112 and the second comment 114 is lower. In this updating manner, the second set of parameters of the similarity evaluation model 330 can be updated to a trend of providing a lower similarity probability for different comments.

In some embodiments, the updating amplitude of the second parameter set may also be based on the gradients of the loss function [symbol] _{U} determined by the [symbol] _{U} loss function module 352, since the loss function [symbol] _{U} involves the first similarity measure P_{i,j} 332, so it is related to the parameters in the second set of parameters.

In some embodiments, the labeled comments 112 input to the comment evaluation model 106 along with the unlabeled comments 114 may also work on the updating of the first set of parameters. For example, the system 300 may further include an [symbol] _{L} loss function module 354 configured to determine how to update the current values of the first set of parameters of the comment evaluation model 106 based on the labeled comments (e.g., the comment 112). For example, the usefulness degree evaluation portion 304 of the comment evaluation model 106 is configured to process the first comment 311 based on the current values of the first set of parameters to determine the estimated degree 321 (represented as “ŷᵢ”) of usefulness corresponding to the first comment 112. Assuming that the actual degree of usefulness of the first comment 112 is represented as “yᵢ”, the [symbol] _{L} loss function module 354 can determine the gradient of the loss function related to the labeled comment based on the actual degree of usefulness and the estimated degree of usefulness, and the current values of the first set of parameters is updated based on the calculated gradients to obtain the updated values. The loss function gradient determined by the [symbol] _{L} loss function module 354 for labeled comments can be represented as:

$$∇ {ℒ}_{L} = ∇ {\sum }_{i = 1}^{N} ( {y}_{i} - 1 ) log ( 1 - {\hat{y}}_{i} ) - {y}_{i} log ( {\hat{y}}_{i} ) \qquad ( 4 )$$

where [symbol] _{L} represents the loss function associated with labeled comments, and N represents the number of labeled comments in a set of comments used for training. Based on formula (4), the system 300 may update the first set of parameters of the comment evaluation model 106 so that the updated values cause the estimated evaluation result determined by the comment evaluation model 106 for the labeled comment to be closer to the actual evaluation result.

In some embodiments, labeled comments and unlabeled comments can be combined to update the current values of the first set of parameters. For example, the system 300 may use a total loss function gradient (denoted as “∇ [symbol] ”) determined by the [symbol] _{U} loss function module 352 and the [symbol] _{L} loss function module 354 together to update the current values of the first set of parameters. The total loss function gradient can be represented as:

∇ [symbol] =λ∇ [symbol] _{L}+(1−λ)∇ [symbol] _{U} (5)

where λ is a preset value indicating the weight of the [symbol] _{L} loss function and the [symbol] _{U} loss function on influencing the total loss function, and can be set to any preset value between 0 and 1 as needed.

The parameter updating process for the comment evaluation model 106 is described above. Through the system 300, the first set of parameters of the comment evaluation model 106 may be updated with unlabeled comments. The computing device 102 may continuously and randomly select comment samples for training from the set of comments used for training. If the pair of comments selected by the computing device 102 are labeled comments, the computing device 102 may consider how to learn the first set of parameters from these comments in an updating manner related to the labeled comments (for example, the loss function gradient indicated by formula (4)). In such a case, the system 300 may not be used. If the pair of comments randomly selected by the computing device 102 are both unlabeled comments, this selection may be discarded. In some embodiments, the computing device 102 is configured to select a pair of comments including a labeled comment and an unlabeled comment at a certain ratio. In this way, a small number of labeled comments and a large number of unlabeled comments can be used to perform model parameter updating.

As mentioned above, the comment evaluation model 106 can be designed as any learning model that can be used to determine the degree of usefulness of the comment. In order to fully understand the first set of parameters of the comment evaluation model 106, the following describes an internal processing of the comment evaluation model 106 and the parameters used with a specific example. It is understood that the described examples do not place any limitation on the scope of the disclosure.

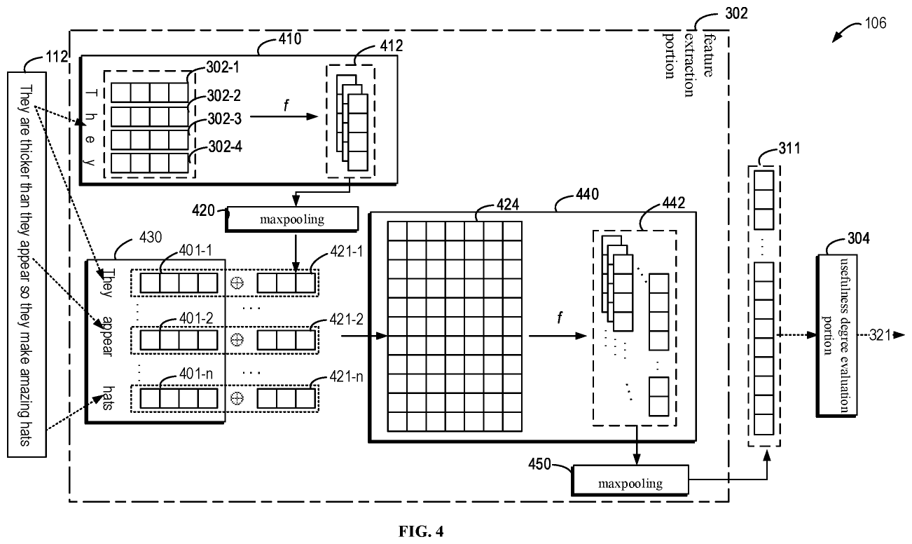

FIG. 4 is a schematic diagram of an example structure of the comment evaluation model 106 according to some embodiments of the disclosure. The feature extraction portion 302 of the comment evaluation model 106 is configured to extract a feature of an input comment, and the usefulness degree evaluation portion 304 is configured to determine an estimated degree of usefulness of the comment based on the feature. For ease of description, the processing of the comment 112 in the comment evaluation model 106 is described as an example. For any other comment, the comment evaluation model 106 is configured to process in a similar manner to extract the feature and determine an estimated degree of usefulness.

In the example of FIG. 4, each text item of the comment 112 is inputted to the feature extraction portion 302 for processing. The text item refers to an item obtained by dividing the text of the comment 112 according to a specific granularity. The granularity of text items is related to the language of the text of the comment. For example, if the comment contains text composed of Latin alphabets such as English, French, German, the comment can be divided by the word level to obtain text items. Each text item includes one words in the comment. If the comment contains hieroglyphs such as Chinese, and Japanese, the comment can be divided by the phrase level (or vocabulary level), and each text item can include a set of words (which include one or more words) in the comment. For Chinese and Japanese text content that cannot be divided by specific identifiers such as spaces, some word segmentation tools can be used to achieve the division of text items.

The feature extraction portion 302 processes the comment 112 at different levels of granularity. Specifically, the feature extraction portion 302 mainly includes a first-level encoding module 410, a second-level encoding module 420, and a third-level encoding module 440. The first-level encoding module 410 is configured to process based on, for example, the character level of each word (or the word of each phrase) in the comment 112, and the second-level encoding module 430 is configured to process based on, for example, the word level (or phrase) of the comment 112, and the third-level encoding module 440 is configured to process based on the overall comment level. Since the comment 112 contains an English text, the following description uses different levels of processing in the English text as an example.

Specifically, the second-level encoding module 430 is configured to obtain vectorized representations 401-1, 401-2, . . . , 401-n (collectively referred to as a vectorized representation 401) of each word of the comment Xᵢ 112, where n represents the number of words included in the comment 112. The vectorized representation 401 of each word can also be referred to as encoding of each word. Assuming that the word at k-th index position in the comment 112 xᵢ is defined as wᵢ^{k}, then the comment 112 as a sequence of length n can be represented as: wᵢ^{1:n}=[wᵢ¹⊕wᵢ²⊕ . . . ⊕wᵢⁿ]. Also, assuming that the word encoding (or vectorization representation) corresponding to the word wᵢ^{k} is vector at dimension d, i.e., wᵢ^{k}∈R^{d}.

The first-level encoding module 410 is configured to obtain a vectorized representation of each character in each word of the comment xᵢ 112. For example, for the first word “They” of the comment 112, the vectorized representation 302-1 of the character “T”, the vectorized representation 302-2 of the character “h”, the vectorized representation 302-3 of the character “e”, and the vectorized representation 302-4 of the character “y” may be obtained. Such a vectorized representation is also called as the character encoding of each character. For other words in the comment 112, vectorized representations of the characters included in these words can also be obtained accordingly.

Assuming that the word wᵢ^{k} in the comment 112 includes m consecutive characters, in which the s-th character can be represented as h_{i,k}^{s}, the sequence composed of all the characters is: h_{i,k}^{1:m}=[h_{i,k}¹⊕h_{i,k}²⊕ . . . ⊕h_{i,k}^{m}], where h_{i,k}^{s}∈R^{d′}. In order to obtain the encoding of the word wᵢ^{k} at the character level, a convolutional neural network (CNN) is used to process the vectorized representations of each word to generate character encodings 412 at the same dimension for words of different length (i.e., including different number of characters). Specifically, a set of convolution filters W′=[w′₁, w′₂, . . . , w′_{k′}] can be adopted, in which each w′ⱼ∈R^{d′×l′} represents a parameter of the filter. This filter is capable of convolving a sequence of consecutive lengths of l′ (i.e., a vectorized representation of l′ consecutive characters). Through a convolution filter, the information of a sequence of characters h_{i,k}^{s:s+l′} of length l′ can be mapped to a scalar value f_{i,k}^{j,s}, which is represented as follows:

f_{i,k}^{j,s}=tanh(w′ⱼ·h_{i,k}^{s:s+l′}+bⱼ′) (6)

where, bⱼ′ is an offset parameter, w′ⱼ and bⱼ′ are both part of the parameter set in the comment evaluation model 106. The filter w′ⱼ is slided from the first character of the word until the end of the character sequence, to obtain a feature dictionary f_{i,k}^{j}=[f_{i,k}^{j,1}, f_{i,k}^{j,2}, . . . , f_{i,k}^{j,m-l′+1}].

For the vector encoding 412 extracted for each word, the feature extraction portion 302 further includes a Maxpooling module 420 to implement a maximum pooling operation to obtain processed character encodings 421-1, 421-2, . . . 421-n (collectively referred to as the vectorized representation 421), which is represented as:

cᵢ^{k}=[max(f_{i,j}¹), max(f_{i,j}²), . . . , max(f_{i,j}^{k′})]^{T}. (7)

The output vectorized representations 401 and 421 of the second-level encoding module 420 and the first-level encoding module 410 may be combined together. For any word in the comment 112, the combined vectorized representation is expressed as: eᵢ^{k}=wᵢ^{k}⊕cᵢ^{k}. Thus, the intermediate feature 424 of the comment 112 is represented as: rᵢ=[eᵢ¹⊕eᵢ²⊕ . . . ⊕eᵢⁿ].

The intermediate feature 424 of the comment 112 may be processed by the third-level encoding module 440. The third-level encoding module 440 is configured to process the intermediate feature 424 in order to extract a final feature of the comment 112. Similar to the first-level encoding module 410, the third-level encoding module 440 is configured to perform convolutional encoding on eᵢ^{1:n} using another set of convolution filters W=[w₁, w₂, . . . ,Wₖ], to output another intermediate feature 442. Any filter wⱼ can sequentially scan a consecutive subsequence rᵢ^{s:s+l} of length l on rᵢ, and perform a convolution operation to obtain gᵢ^{j,s}, which is represented as:

gᵢ^{j,s}=tanh(wⱼ·rᵢ^{s:s+l}+bⱼ). (8)

where, bⱼ is an offset parameter, wⱼ and bⱼ are both part of the parameter set in the comment evaluation model 106. The filter wⱼ is slided from the first character of the word until the end of the character sequence, to obtain a feature dictionary: gᵢ^{j}=[gᵢ^{j,1}, gᵢ^{j,2}, . . . , gᵢ^{j,n-l+1}].

Further, similar to the output of the first-level encoding module 410, the feature extraction portion 302 further includes a maxpooling module 450 to further perform a maximum pooling operation on the intermediate feature 442 output by the third-level encoding module 440, to obtain a final feature of the comment 112: sᵢ=[max(gᵢ¹), max(gᵢ²), . . . , max(gᵢ^{k})].

The feature Sᵢ is processed by the usefulness degree evaluation module 304 to determine the estimated degree of usefulness of the comment 112. The usefulness degree evaluation module 304 can be implemented as a fully connected layer, and the determination of the estimated degree of usefulness can be represented as:

ŷᵢ=σ(wₗ^{T}sᵢ+bₗ) (9)

wherein wₗ and bₗ are part of the parameter set in the comment evaluation model 106.

In the comment evaluation model 106 in FIG. 4, the first set of parameters to be determined through the training process includes at least: parameters w′ⱼ and offset parameters b_{j′} of each filter in the first-level encoding module 410, parameters Wⱼ and offset parameters bⱼ of each filter in the third-level encoding module 440, and parameters wₗ and bₗ in the usefulness degree evaluation module 304. In the comment evaluation model 106, there are also some parameters that can be automatically or manually set to fixed values, such as the parameters l, l′,k, k′, d, d′, λ. These parameters can be called hyper-parameters. In addition, the character-level encoding extracted by the first-level encoding module 410 and the word-level encoding extracted by the second-level encoding module 430 may be obtained from a preset codebook or adjusted during the training process. If the latter scheme is adopted, the character-level encoding and the word-level encoding are also used as parameters in the first set of parameters, and can be updated and determined according to the embodiments of the disclosure.

According to the embodiments of the disclosure, an automatic, efficient, and low-cost model parameter updating scheme is provided, which can be used to train a comment evaluation model that is constructed to evaluate the degree of usefulness of a comment. The trained comment evaluation model is used to evaluate any input comments to determine the degrees of usefulness. According to actual application scenarios, such evaluation results can be used for multiple purposes. For example, in some applications, comments on specific objects in an Internet platform or site can be evaluated, so that comments that are marked as “useful” or “valuable” can be preferentially presented. Comments being preferentially presented can help other users quickly capture useful information from numerous comments, so they can understand or evaluate features of all aspects of a particular object. In other applications, other decisions can also be performed based on the evaluation results of comments on specific objects, such as recommendation decisions on specific objects, and so on. It is understood that the above are just some example applications of evaluation results, and embodiments of the disclosure are not limited in this regard.

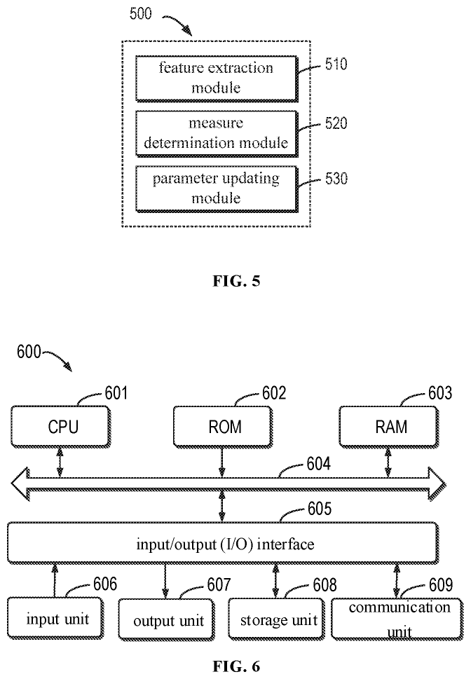

FIG. 5 is a block diagram of an apparatus 500 for updating model parameters according to an embodiment of the disclosure. The apparatus 500 may be included in or implemented as the computing device 102 of FIG. 1. As illustrated in FIG. 5, the apparatus 500 includes a feature extraction module 510 configured to, according to current values of a first set of parameters of a comment evaluation model, extract a first feature of a first comment and a second feature of a second comment by using the comment evaluation model, in which the comment evaluation model is configured to evaluate a degree of usefulness of a comment; a measure determination module 520, configured to determine at least one similarity measure of the first comment and the second comment based on the first feature and the second feature; and a parameter updating module 530, configured to, in response to the first comment being marked with a corresponding actual degree of usefulness and the second comment not being marked with a corresponding actual degree of usefulness, update the current values of the first set of parameters at least based on the at least one similarity measure so as to obtain updated values of the first set of parameters.

In some embodiments, the measurement determination module 520 includes: a first similarity determination module, configured to process the first feature and the second feature using a similarity evaluation model to determine a first similarity measure of the first comment and the second comment based on current values of a second set of parameters of the similarity evaluation model; and a second similarity determination module, configured to determine a second similarity measure of the first comment and the second comment by calculating a difference between the first feature and the second feature.

In some embodiments, the parameter updating module 530 includes: a first updating module, configured to, in response to that the first similarity measure exceeds a preset threshold, update the current values of the first set of parameters based on the first similarity measure and the second similarity measure to obtain the updated values of the first set of parameters, in which the updated values prompt the comment evaluation model to extract features with a smaller difference for the first comment and the second comment.

In some embodiments, the parameter updating module 530 includes: a second updating module, configured to, in response to that the first similarity measure does not exceed a preset threshold, update the current values of the first set of parameters based on the first similarity measure and the second similarity measure to obtain the updated values of the first set of parameters, in which the updated values prompt the comment evaluation model to extract features with a greater difference for the first comment and the second comment.

In some embodiments, the parameter updating module 530 is further configured to update the current values of the second set of parameters based on the first similarity measure and the second similarity measure to obtain updated values of the second set of parameters.

In some embodiments, the parameter updating module 530 includes: a third updating module, configured to, in response to that the first similarity measure exceeds a preset threshold, update the current values of the second set of parameters based on the first similarity measure and the second similarity measure to obtain the updated values of the first second of parameters, in which the updated values of the second set prompt the similarity evaluation model to determine that the similarity between the first comment and the second comment is higher.

In some embodiments, the parameter updating module 530 includes: a fourth updating module, configured to, in response to that the first similarity measure does not exceed a preset threshold, update the current values of the second set of parameters based on the first similarity measure and the second similarity measure to obtain the updated values of the second set of parameters, in which the updated values of the second set prompt the similarity evaluation model to determine that the similarity between the first comment and the second comment is lower.

In some embodiments, the parameter updating module 530 includes a fifth updating module, configured to: process the first feature using the comment evaluation model based on the current values of the first set of parameters to determine an estimated degree of usefulness corresponding to the first comment; and update the current values of the first set of parameters based on the actual degree of usefulness and the estimated degree of usefulness.

FIG. 6 is a block diagram of an example device 600 capable of implementing various embodiments of the disclosure. The device 600 is configured to implement the computing device 120 of FIG. 1. As shown, the device 600 includes a central processing unit (CPU) 601 to perform various appropriate actions and processes according to computer program instructions stored in a read only memory (ROM) 602, or loaded from a storage unit 608 into a random-access memory (RAM) 603. In the RAM 603, various programs and data required for the operation of the storage device 600 can also be stored. The CPU 601, the ROM 602, and the RAM 603 are connected to each other through a bus 604. An input/output (I/O) interface 605 is also connected to the bus 604.

Components in the device 600 are connected to the I/O interface 605, including: an input unit 606, such as a keyboard, a mouse; an output unit 607, such as various types of displays, speakers; a storage unit 608, such as a disk, an optical disk; and a communication unit 609, such as network cards, modems, wireless communication transceivers, and the like. The communication unit 609 allows the device 600 to exchange information/data with other devices through a computer network such as the Internet and/or various telecommunication networks.

The computing unit 601 performs various methods and processes described above, such as the process 200. For example, in some embodiments, the process 200 may be implemented as computer software programs that are tangibly embodied on a machine-readable medium, such as the storage unit 608. In some embodiments, part or all of the computer program may be loaded and/or installed on the device 600 via the ROM 602 and/or the communication unit 609. When a computer program is loaded into the RAM 603 and executed by the CPU 601, one or more steps of the process 200 described above may be performed. Alternatively, in other embodiments, the CPU 601 may be configured to perform the process 200 in any other suitable manner (e.g., by means of firmware).

The functions described above herein may be performed, at least in part, by one or more hardware logic components. For example, unlimitedly, exemplary types of hardware logic components that may be used include: Field Programmable Gate Arrays (FPGAs), Application Specific Integrated Circuits (ASICs), Application Specific Standard Products (ASSPs), System on Chip (SOCs), Load programmable logic devices (CPLDs) and so on.

Program code for implementing the methods of the disclosure may be written in any combination of one or more programming languages. These program codes may be provided to a processor or controller of a general computer, a dedicated computer, or other programmable data processing device, such that the program codes, when executed by the processor or controller, cause the functions and/or operations specified in the flowcharts and/or block diagrams is performed. The program code can be executed entirely on the machine, partly on the machine, as a stand-alone software package partly on a machine and partly on a remote machine or entirely on a remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), erasable programmable read-only memories (EPROM or flash memory), fiber optics, compact disc read-only memories (CD-ROM), optical storage devices, magnetic storage devices, or any suitable combination of the foregoing.

Furthermore, although the operations are depicted in a particular order, this should be understood as requiring that such operations be performed in the shown particular order or in sequential order, or that all illustrated operations be performed to achieve the desired result. Under certain circumstances, multitasking and parallel processing may be advantageous. Likewise, although several specific implementation details are included in the discussion above, these should not be construed as limiting the scope of the disclosure. Certain features that are described in the context of separate embodiments can also be implemented in combination in a single implementation. Conversely, various features that are described in the context of a single implementation can also be implemented in multiple implementations individually or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely example forms for implementing the claims.

What is claimed is:

1. A method for updating model parameters, comprising:
according to current values of a first set of parameters of a comment evaluation model, extracting a first feature of a first comment and a second feature of a second comment by using the comment evaluation model, wherein the comment evaluation model is configured to evaluate a degree of usefulness of a comment;
determining at least one similarity measure of the first comment and the second comment based on the first feature and the second feature; and
in response to the first comment being marked with a corresponding actual degree of usefulness and the second comment not being marked with a corresponding actual degree of usefulness, updating the current values of the first set of parameters at least based on the at least one similarity measure so as to obtain updated values of the first set of parameters.

2. The method according to claim 1, wherein determining the at least one similarity measure, comprises:
processing the first feature and the second feature using a similarity evaluation model to determine a first similarity measure of the first comment and the second comment based on current values of a second set of parameters of the similarity evaluation model; and
determining a second similarity measure of the first comment and the second comment by calculating a difference between the first feature and the second feature.

3. The method according to claim 2, wherein updating the current values of the first set of parameters comprises:
in response to that the first similarity measure exceeds a preset threshold, updating the current values of the first set of parameters based on the first similarity measure and the second similarity measure to obtain the updated values of the first set of parameters, wherein the updated values prompt the comment evaluation model to extract features with a smaller difference for the first comment and the second comment.

4. The method according to claim 2, wherein updating the current values of the first set of parameters comprises:
in response to that the first similarity measure does not exceed a preset threshold, updating the current values of the first set of parameters based on the first similarity measure and the second similarity measure to obtain the updated values of the first set of parameters, wherein the updated values prompt the comment evaluation model to extract features with a greater difference for the first comment and the second comment.

5. The method according to claim 2, further comprising:
updating the current values of the second set of parameters based on the first similarity measure and the second similarity measure to obtain updated values of the second set of parameters.

6. The method according to claim 5, wherein updating the current values of the second set of parameters comprises:
in response to that the first similarity measure exceeds a preset threshold, updating the current values of the second set of parameters based on the first similarity measure and the second similarity measure to obtain the updated values of the second set of parameters, wherein the updated values of the second set prompt the similarity evaluation model to determine that the similarity between the first comment and the second comment is higher.

7. The method according to claim 5, wherein updating the current values of the second set of parameters comprises:
in response to that the first similarity measure does not exceed a preset threshold, updating the current values of the second set of parameters based on the first similarity measure and the second similarity measure to obtain the updated values of the second set of parameters, wherein the updated values of the second set prompt the similarity evaluation model to determine that the similarity between the first comment and the second comment is lower.

8. The method according to claim 1, wherein updating the current values of the first set of parameters comprises:
processing the first feature using the comment evaluation model based on the current values of the first set of parameters to determine an estimated degree of usefulness corresponding to the first comment; and
updating the current values of the first set of parameters based on the actual degree of usefulness and the estimated degree of usefulness.

9. The method according to claim 1, wherein the first comment and the second comment are selected from a set of comments in a random manner.

10. An apparatus for updating model parameters, comprising:
a processor; and
a non-transitory computer readable storage medium storing a plurality of instruction modules that are executed by the processor, the plurality of instruction modules comprising:
a feature extraction module, configured to, according to current values of a first set of parameters of a comment evaluation model, extract a first feature of a first comment and a second feature of a second comment by using the comment evaluation model, wherein the comment evaluation model is configured to evaluate a degree of usefulness of a comment;
a measurement determination module, configured to determine at least one similarity measure of the first comment and the second comment based on the first feature and the second feature; and
a parameter updating module, configured to, in response to the first comment being marked with a corresponding actual degree of usefulness and the second comment not being marked with a corresponding actual degree of usefulness, update the current values of the first set of parameters at least based on the at least one similarity measure so as to obtain updated values of the first set of parameters.

11. The apparatus according to claim 10, wherein the measurement determination module comprises:
a first similarity determination module, configured to process the first feature and the second feature using a similarity evaluation model to determine a first similarity measure of the first comment and the second comment based on current values of a second set of parameters of the similarity evaluation model; and
a second similarity determination module, configured to determine a second similarity measure of the first comment and the second comment by calculating a difference between the first feature and the second feature.

12. The apparatus according to claim 11, wherein the parameter updating module comprises:
a first updating module, configured to, in response to that the first similarity measure exceeds a preset threshold, update the current values of the first set of parameters based on the first similarity measure and the second similarity measure to obtain the updated values of the first set of parameters, wherein the updated values prompt the comment evaluation model to extract features with a smaller difference for the first comment and the second comment.

13. The apparatus according to claim 11, wherein the parameter updating module comprises:
a second updating module, configured to, in response to that the first similarity measure does not exceed a preset threshold, update the current values of the first set of parameters based on the first similarity measure and the second similarity measure to obtain the updated values of the first set of parameters, wherein the updated values prompt the comment evaluation model to extract features with a greater difference for the first comment and the second comment.

14. The apparatus according to claim 11, wherein the parameter updating module is further configured to update the current values of the second set of parameters based on the first similarity measure and the second similarity measure to obtain updated values of the second set of parameters.

15. The apparatus according to claim 14, wherein the parameter updating module further comprise:
a third updating module, configured to, in response to that the first similarity measure exceeds a preset threshold, update the current values of the second set of parameters based on the first similarity measure and the second similarity measure to obtain the updated values of the first second of parameters, wherein the updated values of the second set prompt the similarity evaluation model to determine that the similarity between the first comment and the second comment is higher.

16. The apparatus according to claim 14, wherein the parameter updating module further comprise:
a fourth updating module, configured to, in response to that the first similarity measure does not exceed a preset threshold, update the current values of the second set of parameters based on the first similarity measure and the second similarity measure to obtain the updated values of the second set of parameters, wherein the updated values of the second set prompt the similarity evaluation model to determine that the similarity between the first comment and the second comment is lower.

17. The apparatus according to claim 10, wherein the parameter updating module further comprises a fifth updating module configured to:
process the first feature using the comment evaluation model based on the current values of the first set of parameters to determine an estimated degree of usefulness corresponding to the first comment; and
update the current values of the first set of parameters based on the actual degree of usefulness and the estimated degree of usefulness.

18. The apparatus according to claim 10, wherein the first comment and the second comment are selected from a set of comments in a random manner.

19. A non-transient computer-readable storage medium having a computer program stored thereon, wherein when the computer program is executed by a processor, a method for updating model parameters is implemented, the method comprising:
according to current values of a first set of parameters of a comment evaluation model, extracting a first feature of a first comment and a second feature of a second comment by using the comment evaluation model, wherein the comment evaluation model is configured to evaluate a degree of usefulness of a comment;
determining at least one similarity measure of the first comment and the second comment based on the first feature and the second feature; and
in response to the first comment being marked with a corresponding actual degree of usefulness and the second comment not being marked with a corresponding actual degree of usefulness, updating the current values of the first set of parameters at least based on the at least one similarity measure so as to obtain updated values of the first set of parameters.

20. The non-transient computer-readable storage medium of claim 19, wherein determining the at least one similarity measure, comprises:
processing the first feature and the second feature using a similarity evaluation model to determine a first similarity measure of the first comment and the second comment based on current values of a second set of parameters of the similarity evaluation model; and
determining a second similarity measure of the first comment and the second comment by calculating a difference between the first feature and the second feature.
